(19) United States
(12) Patent Application Publication
(10) Pub. No.: US 2024/0207790 A1
(43) Pub. Date: Jun. 27, 2024

(54) CLOSED LOOP AZEOTROPE-BASED SOLVENT EXTRACTION AND RECOVERY METHOD IN THE PRODUCTION OF MICROPOROUS MEMBRANES

(71) Applicant: Amtek Research International LLC, Lebanon, OR (US)

(72) Inventors: Robert Waterhouse, Lebanon, OR (US); Cory S. Rogers, Eugene, OR (US); Eric B. Hostetler, Corvallis, OR (US); Richard W. Pekala, Corvallis, OR (US)

(21) Appl. No.: 18/558,064

(22) PCT Filed: Jun. 10, 2022
(86) PCT No.: PCT/US2022/072875

§ 371 Date: Oct. 30, 2023

Related U.S. Application Data
(60) Provisional application No. 63/210,382, filed on Jun. 14, 2021.

(51) Int. Cl. B01D 67/00; B01D 53/04; B01D 69/06; B01D 71/26; H01M 50/403; H01M 50/417; H01M 50/463

(52) U.S. Cl. CPC B01D 67/003; B01D 53/04; B01D 67/0018; B01D 67/0027; B01D 69/06; B01D 71/261; H01M 50/403; H01M 50/417; H01M 50/463; B01D 2259/4009; B01D 2323/219; B01D 2323/60

(57) ABSTRACT

An environmentally friendly closed loop manufacturing process (10₁, 10₂) produces microporous membranes (32) by cast or extrusion of polymer-plasticizer mixtures followed by non-porous film formation (20), extraction (22) of the plasticizer using an azeotrope solvent and thereby forming a solvent-laden sheet and a mixture of plasticizer and azeotrope solvent, distillation (28) of the mixture to separate the plasticizer and azeotrope solvent for reuse, evaporation (30) of the azeotrope solvent from the solvent-laden sheet to form the micropores, and capture of the resultant solvent vapor for subsequent adsorption-desorption of the azeotrope solvent from activated carbon (34) or by vapor condensation (36) for reuse in the manufacturing process. The azeotrope solvent is at least a two-component mixture of solvents, one of which is designed for efficient removal of the plasticizer, while the other component(s) render(s) the azeotrope solvent non-flammable.

### RELATED APPLICATION

This application claims benefit of U.S. Patent Application No. 63/210,382, which was filed Jun. 14, 2021, and is incorporated by reference in its entirety.

### COPYRIGHT NOTICE

© 2022 Amtek Research International LLC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This disclosure relates to the production of microporous membranes and, in particular, to an environmentally friendly closed loop process that extracts with an azeotrope solvent the plasticizer from an extruded polymer-plasticizer mixture in sheet form, evaporates the azeotrope solvent to form micropores in the membrane, and subsequently adsorbs and desorbs the azeotrope solvent for reuse.

### BACKGROUND INFORMATION

Microporous membranes have a structure that is designed for fluid flow through them. The fluid can be either a liquid or a gas, and generally the pore size of the membrane is at least several times the mean free path of the fluid to achieve the desired flux. The pore size range for microporous membranes is generally from 10 nanometers to several microns, with an average pore size less than 1 micrometer. Such membranes are generally opaque because the pore diameter and polymer matrix are of sufficient sizes to scatter visible light. The term “microporous membrane,” as used herein, is inclusive of other descriptions used in the scientific and patent literature such as “microporous films,” “microporous sheets,” and “microporous webs.”

Microporous membranes have been utilized in a wide variety of applications such as filtration, breathable films for garment or medical gown applications, battery separators, synthetic printing sheets, and surgical dressings. In some cases, the microporous membranes are laminated to other articles (e.g., a non-woven article) to impart additional functionality (e.g., tear resistance, oxidation resistance). The microporous membrane may also undergo machine- or transverse-direction stretching as part of the manufacturing process or in a secondary step.

The manufacture of microporous membranes generally falls into four categories:

1. Cavitation. Extrusion of a non-porous polymer sheet followed by subsequent stretching to induce porosity formation. Diaper films are often manufactured from CaCO₃-filled polyolefin membranes that are then stretched to induce pores or voids at the filler-polymer interface. Isotactic polypropylene can also be extruded into a non-porous sheet that is subsequently stretched to induce voids or porosity as a result of a beta- to alpha-crystal transformation. Such films have been used as battery separators.

2. Sacrificial Pore Former. Extrusion of a non-porous polymer sheet containing a large percentage of inorganic filler that is subsequently extracted to form interconnected porosity. For example, sodium sulfate has been extruded with polyethylene and then subsequently extracted with and dried from water to form a battery separator.

3. Non-Solvent Induced Phase Separation. In this approach, a polymer is dissolved in a solvent to form a homogenous solution that is then cast onto a belt or plate that is subsequently dipped through a non-solvent for the polymer. For example, polysulfone can be readily dissolved in dimethyl sulfoxide and then cast into a thin film on a glass plate. The cast film is then placed in a water bath to induce phase separation of the polymer and subsequent pore formation upon evaporation of the solvent. This approach is commonly used to produce asymmetric membranes, meaning that there is a pore size difference from one face of the membrane to the other.

4. Thermally Induced Phase Separation. In this process, a homogeneous mixture is formed by melt blending the polymer with a thermally stable plasticizer (e.g., paraffin oil) at elevated temperature and then casting or extruding the polymer-plasticizer mixture into a non-porous film or object. The non-porous film or object is cooled to induce phase separation of the polymer and plasticizer, often as a result of polymer re-crystallization. The plasticizer is then removed by solvent extraction and drying to form a microporous membrane. To facilitate the separation and recycling of solvent and plasticizer, their boiling points are greater than 50° C. apart.

### Description of Problem to be Solved

Battery separators are commonly manufactured using a thermally induced phase separation process, followed by extraction of the thermally stable plasticizer with hexane, trichloroethylene, methylene chloride, or other solvents. Government regulatory agencies continue to conduct risk evaluations on such solvents and have concerns regarding environmental and worker exposures.

Most flooded lead (Pb)-acid batteries include polyethylene separators. The term “polyethylene separator” is a misnomer because these microporous separators require large amounts of an inorganic filler, such as precipitated silica, to be sufficiently acid wettable. The volume fraction of precipitated silica and its distribution in the separator generally controls its electrical (ionic) properties, while the volume fraction and orientation of polyethylene in the separator generally controls its mechanical properties. The porosity range for commercial polyethylene separators is generally 50%-65%.

In the case of Pb-acid separators, they are commonly manufactured using a thermally induced phase separation process. Initially, precipitated silica is combined with a polyolefin, a plasticizer (i.e., process oil), and various minor ingredients to form a separator mixture that is extruded at elevated temperature through a sheet die to form an oil-filled sheet. The oil-filled sheet is calendered to its desired thickness and profile, and the majority of the process oil is extracted with an organic solvent. Hexane and trichloroethylene have been the two most common solvents used in Pb-acid separator manufacturing. The solvent-laden sheet is then dried to form a microporous polyolefin separator and is slit into an appropriate width for a specific battery design.

The polyethylene separator is delivered in roll form to Pb-acid battery manufacturers, where the separator is fed to a machine that forms “envelopes” by cutting the separator material and sealing its edges such that an electrode can be inserted to form an electrode package. The electrode packages are stacked such that the separator acts as a physical spacer and an electronic insulator between positive and negative electrodes. Sulfuric acid is then introduced into the assembled battery to facilitate ionic conduction within the battery. FIG. 1A shows an exemplary battery separator sheet having on one side embossed ribs and configured for installation in a Pb-acid battery assembly of a type shown in FIG. 1C. (A battery separator sheet may alternatively have ribs embossed on both of its sides.) FIG. 1B is a diagram of a battery separator envelope formed from the battery separator sheet of FIG. 1A and shown with an open end into which a wire-grid electrode is inserted partway. FIG. 1C shows groups of the electrode packages assembled as cells that are connected with metal strips to conduct electricity from one cell to the next. The separator acts as a physical spacer and an electronic insulator between the electrodes.

The primary purposes of the polyolefin contained in the separator are to (1) provide mechanical integrity to the polymer matrix so that the separator can be enveloped at high speeds and (2) to prevent grid wire puncture during battery assembly or operation. Thus, the hydrophobic polyolefin preferably has a molecular weight that provides sufficient molecular chain entanglement to form a microporous web with high puncture resistance. The primary purpose of the hydrophilic silica is to increase the acid wettability of the separator web, thereby lowering the electrical resistivity of the separator. In the absence of silica, the sulfuric acid would not wet the hydrophobic web and ion transport would not occur, resulting in an inoperative battery. Consequently, the silica component of the separator typically accounts for between about 55% and about 80% by weight of the separator, i.e., the separator has a silica-to-polyethylene weight ratio of between about 2.0:1 and about 3.5:1.

Separators designed for Li-ion, primary Li-metal, or rechargeable Li-metal battery systems are commonly manufactured using a thermally induced phase separation process. In this case, various grades of polyethylene ranging in molecular weight from 500,000 g/mol to 10 million g/mol are combined with a plasticizer (e.g., paraffin oil) and then extruded through a sheet die or annular die to form an oil-filled sheet. The oil-filled sheet is often biaxially oriented to decrease its thickness and improve mechanical properties in both the machine- and transverse-directions. Next, the biaxially oriented sheet is most often passed through an extraction bath of methylene chloride to remove the plasticizer and subsequently create pores upon evaporation of the solvent. The resultant battery separator typically has thickness in the 3 μm-25 μm range with porosity between 35%-65%.

The manufacture of microporous membranes for synthetic printing applications is exemplified by Schwarz et al. in U.S. Pat. No. 5,196,262. In this case, the polymer matrix constitutes a blend of ultrahigh molecular weight polyethylene (UHMWPE) having an intrinsic viscosity >10 dl/g and lower molecular weight polyethylene with a melt flow index <50 g/10 min (ASTM D 1238-86 condition). These polymers are combined with a high percentage of finely divided, water-insoluble siliceous filler, other minor ingredients, and a processing plasticizer to form a mixture that is subsequently extruded into a sheet from which the majority of the plasticizer is extracted with a solvent. Examples of suitable organic extraction liquids include trichloroethylene, perchloroethylene, methylene chloride, hexane, heptane, and toluene. The resultant microporous membranes are sold by PPG Industries under the Teslin® trademark.

In response to ongoing environmental pressures and health concerns related to organic solvents such as trichloroethylene, methylene chloride, and hexane, there is a need for a new sustainable approach to the manufacture of microporous membranes that can meet customer performance requirements from a process that minimizes worker exposure to toxic substances and efficiently recycles the extraction solvent and plasticizer in a closed loop.

### SUMMARY OF THE DISCLOSURE

An environmentally friendly closed loop manufacturing process produces a microporous membrane formed from thermally induced phase separation of polymer and plasticizer materials. The microporous membrane exhibits freestanding properties, has a thickness, and has interconnecting pores that communicate throughout the thickness. “Freestanding” refers to a sheet having sufficient mechanical properties that permit manipulation such as winding and unwinding in sheet form for use in an energy storage device assembly. The pores are formed with use of a plasticizer extraction solvent to extract the plasticizer material and by subsequent removal of the plasticizer extraction solvent.

The method of producing the microporous membrane entails casting or extruding a mixture of polymer and plasticizer to form a polymer-plasticizer non-porous film. An azeotrope solvent made of a mixture of at least two solvents and applied to the non-porous film includes a first component formulated to extract the plasticizer and a second component formulated to impart a non-flammability property to the azeotrope solvent. Extraction of the plasticizer results in an azeotrope solvent-laden sheet and a mixture of plasticizer and azeotrope solvent. Separation of the plasticizer from the azeotrope solvent recovers the plasticizer and the azeotrope solvent in a purified state for reuse. Applying heat to the azeotrope solvent-laden sheet generates an azeotrope solvent vapor by vaporization of the azeotrope solvent from the azeotrope solvent-laden sheet. The vaporization of the azeotrope solvent results in production of the microporous membrane, and the azeotrope solvent vapor produced is available for azeotrope solvent fluid recovery and reuse.

Additional aspects and advantages will be apparent from the following detailed description of preferred embodiments, which proceeds with reference to the accompanying drawings.

### BRIEF DESCRIPTION OF THE DRAWINGS

FIG. 1A is a pictorial view of a battery separator sheet configured for use in a Pb-acid battery assembly.

FIG. 1B is a diagram of an electrode package shown as an assembly of a wire-grid electrode inserted partway into a battery separator envelope, the envelope cut and formed from the battery separator sheet of FIG. 1A and depicted with one of its sides folded down to show placement of the wire-grid electrode within the battery separator envelope.

FIG. 1C is a pictorial view of the interior of a Pb-acid battery, with a side portion of the battery case removed to show electrode packages assembled as cells that are connected with metal strips to conduct electricity from one cell to the next.

FIG. 2 is a chart summarizing solvent selection criteria for microporous membranes formed from thermally induced phase separation of a polymer-plasticizer blend.

FIG. 3 is a diagram depicting a closed loop azeotrope-based solvent extraction and carbon bed recovery method in the manufacture of microporous membranes.

FIG. 4 is a diagram depicting a closed loop azeotrope-based solvent extraction and vapor condensing recovery method in the manufacture of microporous membranes.

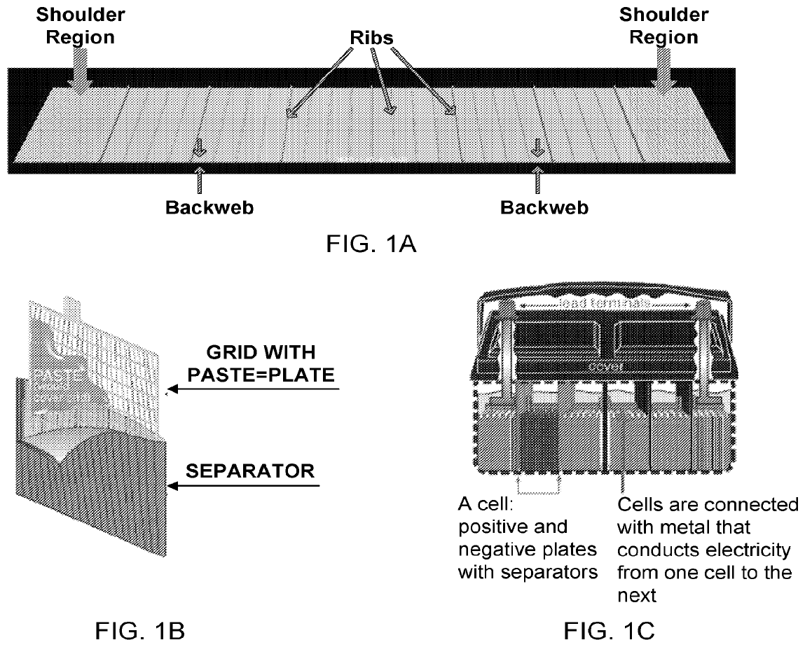

### DETAILED DESCRIPTION OF EMBODIMENTS

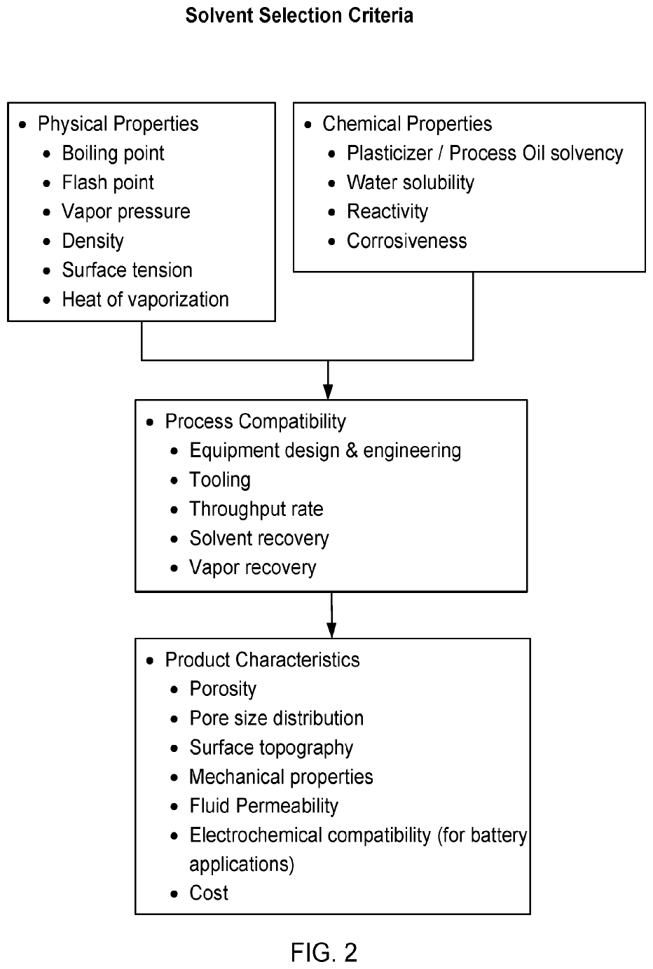

In the manufacture of microporous membranes using thermally induced phase separation, the main considerations for solvent selection include physical properties, chemical properties, equipment compatibility, safety, recyclability, cost, and the ability to achieve the desired product characteristics (e.g., pore size distribution). A summary of solvent selection criteria is shown in FIG. 2.

The task of identifying a single solvent, particularly one that is non-flammable, that can meet all of the selection criteria while also minimizing health and environmental risks presents a difficult challenge. Continued pressure from European Union Registration, Evaluation, Authorisation and Restriction of Chemicals (REACH) and United States Environmental Protection Agency (EPA) regulations to eliminate trichloroethylene and methylene chloride as extraction solvents in the production of microporous membranes used as battery separators compels formulating a new approach to manufacturing microporous membranes.

A mixture of two or more solvents may appear to be an attractive approach to eliminating trichloroethylene and methylene chloride as extraction agents, but applicant has determined the importance of solvents behaving as an azeotrope rather than as an ideal solution. An azeotrope mixture exhibits the same composition in both its liquid phase and vapor phase during distillation. In contrast, an ideal solution would behave as two separate components, with the lower boiling solvent being first removed with the plasticizer from the mixture, followed by removal of the higher boiling solvent. Boiling point and surface tension of the azeotropic solvent are physical properties relevant to the manufacture of microporous membranes. A suitable azeotropic solvent exhibits a boiling point that is significantly lower (at least 100° C.) than the initial boiling point range for the process oil so that, as the mixture is removed from the extractor, the process oil and azeotrope solvent can be easily separated via distillation for reuse in the process. During evaporation of the azeotrope from the solvent-laden sheet, a low surface tension is preferred in order to minimize capillary forces and shrinkage, thereby preserving more porosity in the membrane. A surface tension no greater than 25 dyn/cm at 25° C. is desired, with a preferred range 15-25 dyn/cm.

Although there are many well-known azeotropes (e.g., 95/5 ethanol-water), achieving the combination of good plasticizer/process oil solvency and non-flammability is a difficult challenge. Recently commercially available azeotropes containing one or more fluorinated compounds with trans-dichloroethylene (t-DCE) provide the required combination, even though t-DCE by itself has a flashpoint of only 2° C. Examples of such commercial products include Tergo® MCF (MicroCare Corporation), Novec® 71DE (3M Company), Vertrel® SDG (Chemours Company), and Solvex™ HD Plus (Banner Chemicals Limited).

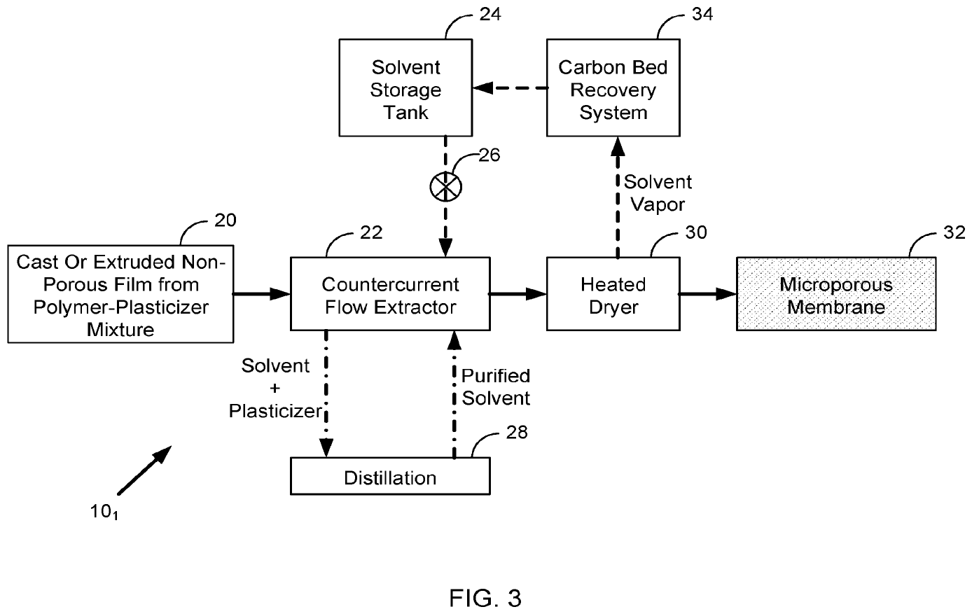

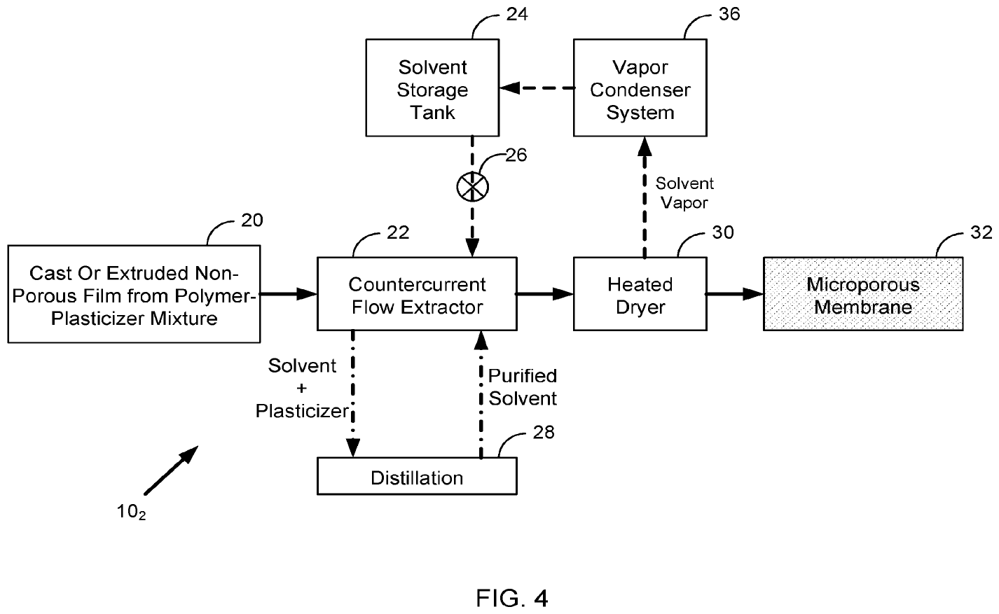

Although azeotropes are sometimes described as constant boiling point mixtures, the adsorption-desorption of azeotropes from activated carbon, as is required in a closed loop recovery system, has not been well studied. Furthermore, the ability to repeatably desorb the azeotrope with steam from an activated carbon bed without impacting the chemistry of the azeotrope has been heretofore unknown. As an alternative, the t-DCE containing azeotropes can be recovered as an “ice” after passing the vapor through an ammonia chiller/heat exchanger system or other vapor condensing recovery system. FIG. 3 depicts a closed loop azeotrope-based solvent extraction and carbon bed recovery method in the manufacture of microporous membranes. FIG. 4 depicts a closed loop azeotrope-based solvent extraction and vapor condensing recovery method in the manufacture of microporous membranes. The following describes, for each of closed loop solvent recovery system embodiments 10₁ and 10₂ outlined in FIGS. 3 and 4, respectively, the process steps performed in extracting the azeotrope solvent and recovering it for reuse.

With reference to FIGS. 3 and 4, a non-porous, plasticizer-filled film formed from a cast or an extruded polymer-plasticizer mixture 20 is passed through a countercurrent flow extractor 22. Azeotrope solvent supplied from a solvent storage tank 24 and flow controlled by a fluid valve 26 flows into countercurrent flow extractor 22 in a direction opposite to that of the film. Extractor 22 produces in a first internal zone a plasticizer-azeotrope solvent mixture, which is pumped to a distillation unit 28, where the plasticizer and azeotrope solvent are separated for reuse. Distillation unit 28 produces an azeotrope solvent condensate in a purified state. The purified azeotrope solvent is returned to a second internal zone of countercurrent flow extractor 22 for reuse in combination with azeotrope solvent supplied from solvent storage tank 24. The solvent-laden film exits countercurrent flow extractor 22 and is passed into a heated dryer 30, which is a source of heat equipped with air knives that evaporate off the azeotrope solvent and thereby produce an azeotrope solvent vapor. A microporous membrane 32 emerges from heated dryer 30.

In solvent recovery system embodiment 10₁, the azeotrope solvent vapor produced by operation of heated dryer 30 is recovered by adsorption-desorption with use of a carbon bed system 34, as shown in FIG. 3. The azeotrope solvent vapor evaporates onto activated carbon, which adsorbs the azeotrope solvent. Steam is then used to thermally desorb the azeotrope solvent from the activated carbon for delivery to storage tank 24.

In solvent recovery system embodiment 10₂, the azeotrope solvent vapor produced by operation of heated dryer 30 is recovered by a vapor condenser system 36, as shown in FIG. 4. The azeotrope solvent vapor enters vapor condenser system 36 for extraction of the latent heat of vaporization from the solvent vapor to thereby cool and condense the azeotrope solvent. The recovered azeotrope solvent is delivered to storage tank 24.

FIGS. 3 and 4 show an outlet of solvent storage tank 24 connected through fluid valve 26 to countercurrent flow extractor 22. This configuration implements closed loop solvent recovery system embodiments in which the recovered azeotrope solvent washes over the plasticizer-filled film to continue plasticizer removal from the sheet passing through countercurrent flow extractor 22.

In some cases, it may be advantageous to combine use of activated carbon and vapor condenser solvent recovery systems for efficient recovery and recycling of the azeotrope solvent. Skilled persons will appreciate that an azeotrope/water liquid phase separation may be a necessary part of the recovery process where steam is utilized as a heat source.

Applicant has surprisingly found that t-DCE containing azeotropes with specific fluorinated compounds can meet the requirements for next generation solvent extraction and recovery processes in the manufacture of microporous membranes. Examples 1 and 2 below describe extrusion-based processing of polymer and plasticizer materials in the production of microporous membranes that are suitable for use in a Pb-acid battery and a Li-ion battery, respectively.

### Example 1

UHMWPE (Celanese GUR 4150), precipitated silica (PPG WB-2085), and minor ingredients (antioxidant, lubricant, and carbon black) were combined in a horizontal mixer and blended with low speed agitation to form a homogeneous mix. Next, hot process oil (ENTEK 800 naphthenic oil; Calumet Specialty Products) was sprayed onto the dry ingredients. This mix contained about 58 wt. % oil and was then fed to a 96-mm counter-rotating twin screw extruder (ENTEK Manufacturing LLC) operating at a melt temperature of about 215° C. Additional process oil was added in-line at the throat of the extruder to give a final oil content of about 65 wt. %. The resultant mass was passed through a sheet die into a calendar and embossed with a rib pattern and a thickness of about 200 μm-300 μm. After passing over two cooling rolls, the oil-filled sheet was collected for extraction of the plasticizer oil.

An about 160 mm×160 mm oil-filled sample was placed in beaker containing an excess quantity of Tergo® MCF solvent and extracted for about 5 minutes at room temperature and then dried in a circulating oven for 10 minutes at 80° C. A second oil-filled sample was placed in trichloroethylene and extracted and dried under identical conditions.

A comparison of the resultant separator properties is shown in Table 1 below:

TABLE 1

| | | | | | Normalized |
|---|---|---|---|---|---|
| | Final | Electrical | Electrical | Puncture | Puncture |
| | Thickness | resistance | resistivity | Resistance | Resistance |
| Solvent | (mm) | (mohm-cm²) | (mohm-cm) | (N) | (N/mm) |
| Tergo ® MCF | 0.198 | 53.4 | 2703 | 5.9 | 30.6 |
| Trichloroethylene | 0.177 | 48.3 | 2753 | 6.0 | 33.7 |

The Tergo® MCF solvent-extracted separators and TCE solvent-extracted separators exhibit comparable electrical resistivity and normalized puncture resistance characteristics. The electrical (ionic) resistance measurements were made with a Palico Model #9100 Measuring System after boiling the samples in water for 10 minutes and soaking for 20 minutes in 1.28 specific gravity sulfuric acid.

### Example 2

A naphthenic process oil (140 kg) was dispensed into a Ross mixer, where the process oil was stirred and degassed. Next, the following were added and mixed with the oil:
64 kg UHMWPE (Molecular weight about 5 million g/mol)
32 kg VHMWPE (Molecular weight about 1 million g/mol)
32 kg HMW-HDPE (Molecular weight about 0.6 million g/mol)
1.2 kg Li Stearate
1.2 kg Antioxidant
   The mixture was blended at about 40° C. until a uniform 47 w/w % polymer slurry was formed. The polymer slurry was then pumped into a 103-mm diameter, co-rotating twin screw extruder (ENTEK Manufacturing LLC), while a melt temperature of about 215° C. was maintained. The extrudate was passed through a melt pump that fed a 257-mm diameter annular die having a 2.75 mm gap. The throughput through the die was 230 kg/hr, and the extrudate was inflated with air to produce a biaxially oriented, oil-filled film with an about 2250 mm diameter, which inflated extrudate was then passed through an upper nip at 20 m/min to collapse the bubble and form a double layer, which was subsequently side-slit into two individual layers.
   An individual oil-filled layer (about 40 μm thick) was then restrained in a metal frame that was clamped together. An about 200 mm×200 mm area of the oil-filled layer was then exposed to an excess quantity of Tergo® MCF solvent for plasticizer oil extraction for about 10 minutes at room temperature while the solvent was agitated. The solvent-laden film was then dried in a circulating air oven for about 5 minutes at 80° C. The membrane was then removed from the frame and found to have a thickness of 39.8 μm with a Gurley air permeability value of 1182 secs/100 cc. Comparable values were obtained for a membrane extracted and dried from trichloroethylene at this same point in the manufacturing process. In many cases, additional biaxial stretching would be performed on the plasticizer oil-extracted membrane to establish its final thickness and porosity for use in a Li-ion battery.

It will be obvious to those having skill in the art that many changes may be made to the details of the above-described embodiments without departing from the underlying principles of the invention. For example, the microporous membranes produced may be used in energy storage devices other than Pb-acid and Li-ion batteries. The scope of the present invention should, therefore, be determined only with reference to the following claims.

1. In a method of producing a microporous membrane formed from thermally induced phase separation of polymer and plasticizer materials, the microporous membrane having a thickness and interconnecting pores that communicate throughout the thickness, the pores formed with use of a plasticizer extraction solvent to extract the plasticizer material and by subsequent removal of the plasticizer extraction solvent, the improvement comprising:
extruding or casting a mixture of polymer and plasticizer to form a polymer-plasticizer non-porous film;
applying to the non-porous film an azeotrope solvent including a first component formulated to extract the plasticizer and a second component formulated to impart a non-flammability property to the azeotrope solvent, the extraction of the plasticizer resulting in an azeotrope solvent-laden sheet and a mixture of plasticizer and azeotrope solvent;
separating the plasticizer from the azeotrope solvent to recover the plasticizer and the azeotrope solvent in a purified state for reuse; and
applying heat to the azeotrope solvent-laden sheet to generate an azeotrope solvent vapor by vaporization of the azeotrope solvent from the azeotrope solvent-laden sheet, the vaporization of the azeotrope solvent resulting in production of the microporous membrane, and the azeotrope solvent vapor produced being available for azeotrope solvent fluid recovery and reuse.

2. The method of claim 1, in which the azeotrope solvent is supplied from storage, and further comprising:
recovering the azeotrope solvent vapor by adsorption in activated carbon; and
desorbing, with use of steam, the adsorbed azeotrope solvent from the activated carbon and delivering to storage the desorbed azeotrope solvent as recovered azeotrope solvent fluid for use in the application to the non-porous film and thereby form a closed-loop azeotrope-based solvent extraction and recovery system in the production of the microporous membrane.

3. The method of claim 2, in which the azeotrope solvent contains trans-dichloroethylene (t-DCE) as the first component and one or more fluorinated compounds as the second component.

4. The method of claim 1, in which the azeotrope solvent is supplied from storage, and further comprising:
recovering the azeotrope solvent vapor and extracting latent heat of vaporization from the azeotrope solvent vapor to cool and condense the azeotrope solvent; and
delivering to storage the condensed azeotrope solvent as recovered azeotrope solvent fluid for use in the application to the non-porous film and thereby form a closed-loop azeotrope-based solvent extraction and recovery system in the production of the microporous membrane.

5. The method of claim 4, in which the azeotrope solvent contains trans-dichloroethylene (t-DCE) as the first component and a fluorinated compound as the second component.

6. The method of claim 1, in which a countercurrent flow extractor applies the azeotrope solvent to the non-porous film to extract the plasticizer from the non-porous film and form the mixture of plasticizer and azeotrope solvent.

7. The method of claim 6, in which a distillation unit receives the mixture of plasticizer and azeotrope solvent and separates them so that the plasticizer and the azeotrope solvent in a purified state are suitable for reuse.

8. The method of claim 1, in which a countercurrent flow extractor applies the azeotrope solvent to the non-porous film to extract the plasticizer from the non-porous film, and in which a heated dryer receives from the countercurrent flow extractor the azeotrope solvent-laden non-porous film and applies to it vaporizing heat that generates the azeotrope solvent vapor for azeotrope solvent fluid recovery and reuse.

9. The method of claim 1, further comprising biaxially stretching the microporous membrane to establish its thickness and porosity.

10. A freestanding microporous membrane, comprising:
a polymer matrix formed from thermally induced phase separation of plasticizer material, the polymer matrix having a thickness and including polyethylene to provide mechanical integrity; and
interconnected pores communicating throughout the thickness of the polymer matrix resulting from extraction of the plasticizer material by a non-flammable azeotrope solvent and its subsequent evaporation.

11. The freestanding microporous membrane of claim 10, in which the non-flammable azeotrope solvent exhibits a surface tension no greater than 25 dyn/cm.

12. The freestanding microporous membrane of claim 11, in which the non-flammable azeotrope solvent exhibits a surface tension between 15-25 dyn/cm.

13. The freestanding microporous membrane of claim 10, in which the plasticizer has an initial boiling point range, and in which the non-flammable azeotrope solvent exhibits a surface tension no greater than 25 dyn/cm and a boiling point that is at least 100° C. below the initial boiling point range of the plasticizer.

14. The freestanding microporous membrane of claim 10, in which the polyethylene comprises one or more of ultrahigh molecular weight polyethylene (UHMWPE), very high molecular weight polyethylene (VHMWPE), or high molecular weight-high density polyethylene (HMW-HDPE).

15. The freestanding microporous membrane of claim 10, in which the polymer matrix further includes an inorganic filler.

16. The freestanding microporous membrane of claim 10, in which the polymer matrix is in sheet form and configured for use in an energy storage device assembly.

17. The freestanding microporous membrane of claim 10, in which the polymer matrix is in sheet form and configured for use as a battery separator.

18. The freestanding microporous membrane of claim 17, in which the battery separator sheet has opposite side surfaces, one or both of which surfaces being embossed with a rib pattern.

19. The freestanding microporous membrane of claim 17, in which the battery separator sheet is biaxially stretched to establish its thickness and porosity.

20. An azeotrope solvent-laden sheet, comprising:
a cast or extruded polyolefin sheet derived from a cast or an extruded mixture of a polyolefin and a plasticizer; and
an azeotrope solvent including a first component formulated to extract the plasticizer and a second component formulated to impart a non-flammability property to the azeotrope solvent.

21-23. (canceled)
